(19) United States
(12) Patent Application Publication
(10) Pub. No.: US 2022/0207510 A1
(43) Pub. Date: Jun. 30, 2022

(54) Method And Device For Making Commercial Or Charitable Payments

(71) Applicant: SCREENLIFE LIMITED, Nicosia (CY)

(72) Inventor: Timur Bekmambetov Nuruachitovich, Moscow (RU)

(21) Appl. No.: 17/543,778

(22) Filed: Dec. 7, 2021

(30) Foreign Application Priority Data
Dec. 31, 2020 (RU) RU2020144258

(51) Int. Cl. G06Q 20/32; G06F 3/02

(52) U.S. Cl. CPC G06Q 20/322; G06Q 30/0279; G06F 3/02

(57) ABSTRACT

The present invention relates to the method and device for making commercial and charitable payments using a device controlled by a processor with the help of a user interface button including a charitable foundation website. The invention is suitable for a mobile phone, smartphone, tablet, computer. In one of its variants, the invention enables a payer to make a payment to a payee for a non-fixed amount by holding down a mobile phone user interface button to generate a payment amount for a certain time.

### CROSS-REFERENCE TO RELATED APPLICATION

This application claims the benefit of priority from RU2020144258, filed Dec. 31, 2020, having the same inventor and the same title, and which is incorporated herein by referenced in its entirety.

### FIELD OF THE INVENTION

The present invention relates to a method of making commercial or charitable payments using a device controlled by a processor with the help of a user interface button installed in a mobile application or website or charitable foundation. The invention is suitable for a mobile phone, tablet, computer.

### BACKGROUND OF THE INVENTION

In the background of the invention, known is US application 20080301046A1 for a method and system for making payments. The invention provides a method and system that facilitate and accelerate electronic transactions between a user of a machine-readable medium (“Payer”) and a merchant or payee (“Payee”), including payments via the Internet. The invention enables the Payer to make a payment to the Payee for the exact desired amount by dragging and dropping a control element of the graphical user interface, dragging and dropping from the graphical element displayed on the Paver's terminal to a visual display of the Payee on the website. The invention can be implemented for online commerce, for mobile payments, for online payments of small amounts, for online donations or for payments using prepaid accounts. The invention can be implemented by an account issuing institution or an organization managing funds and transactions.

A disadvantage of the specified technical solution is an increase in time for making a payment compared to the proposed technical solution, as well as the inability to pay for simultaneously consumed content.

### DISCLOSURE OF THE INVENTION

In one of its variants, the invention enables a payer to make a payment to a payee for a non-fixed amount by holding a mobile phone user interface button to generate a payment amount for a certain time, in particular for at least ten seconds.

The method of implementation of the specified variant of a commercial payment via a user interface button in a mobile application is shown in FIG. 1 and FIG. 2.

The aforementioned method is implemented by providing a commercial service focused on the consumption of commercial content via the Internet using a processor-controlled device, the method comprising the following steps:

connection of the consumer of the Internet services via the aforesaid processor-controlled device and Internet to the service provider;

check of payment of the above-mentioned consumer of Internet services;

initiation of the data streaming of said content-oriented service to the Internet service consumer;

monitoring of the duration of the specified data streaming; and

simultaneous generation of the amount of payment for the service depending on the duration of its streaming, the specified control of the duration of the above data streaming being performed by initially pressing and finally releasing the button on the above-mentioned processor-controlled device.

The aforementioned processor-controlled device comprises a smartphone, a tablet, a personal computer, wherein the increasing amount of payment is transmitted to the consumer of the Internet service during the streaming process, and the button comprises a physical button on the processor-controlled device and/or a virtual button on the processor-controlled device.

It should be noted that in the process of holding the button as shown in FIG. 2, the amount can be formed in proportion to the number of seconds of holding multiplied by a factor or the amount can be formed progressively, i.e. gradually accelerating or decelerating. The above expression can be expressed as S=T*K, where S is the amount; T is milliseconds, and K is the coefficient. It should be noted that the user should be notified on the display of the amount generated at a given moment while holding the above button, and the amount should be updated in real time.

A method of making a charitable payment through the user interface button in the mobile application is shown in FIG. 1 and FIG. 2.

The aforementioned method is implemented via the Internet using a processor-controlled device, whereby the method includes the following steps:
connection of the payer's user via the above processor-controlled device to the payee; check of the payment of the above-mentioned payer;
   initiation of the payer's data streaming via the Internet to the payee;
   monitoring of the duration of the specified data streaming; and
   simultaneous generation of the amount of payment depending on the duration of its streaming, the specified control of the duration of the above data streaming being performed by initially pressing and finally releasing the button on the above-mentioned processor-controlled device.

The technical result of the invention is the simplification and acceleration of the financial transaction and allows payment in proportion to the content actually consumed or being consumed. An additional technical result is the simplification and acceleration of the financial transaction for the charitable foundation.

### BRIEF DESCRIPTION OF THE DRAWINGS

FIG. 1 presents a method of implementation of a commercial payment.

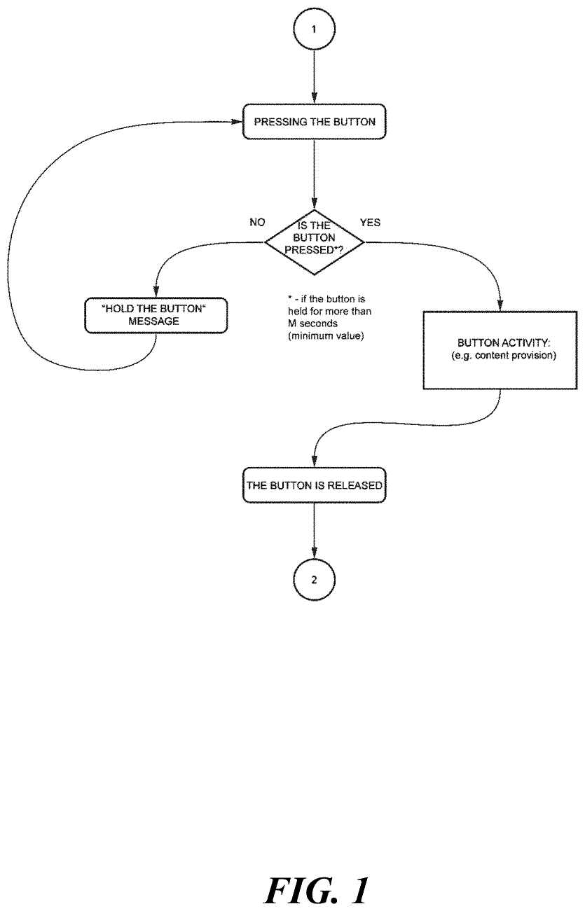

FIG. 2 presents a mobile device and a user interface button in a mobile application with an amount when the button is held down.

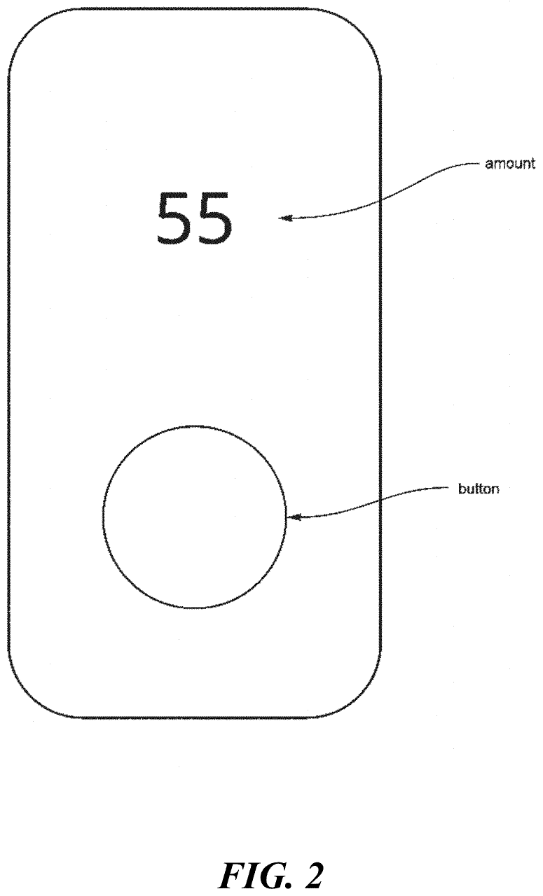

FIG. 3 presents a method of payment, where the button mechanism makes it possible to support payment from a linked bank card or with the opening of the payment gateway and confirmation of the payment transaction after holding the button.

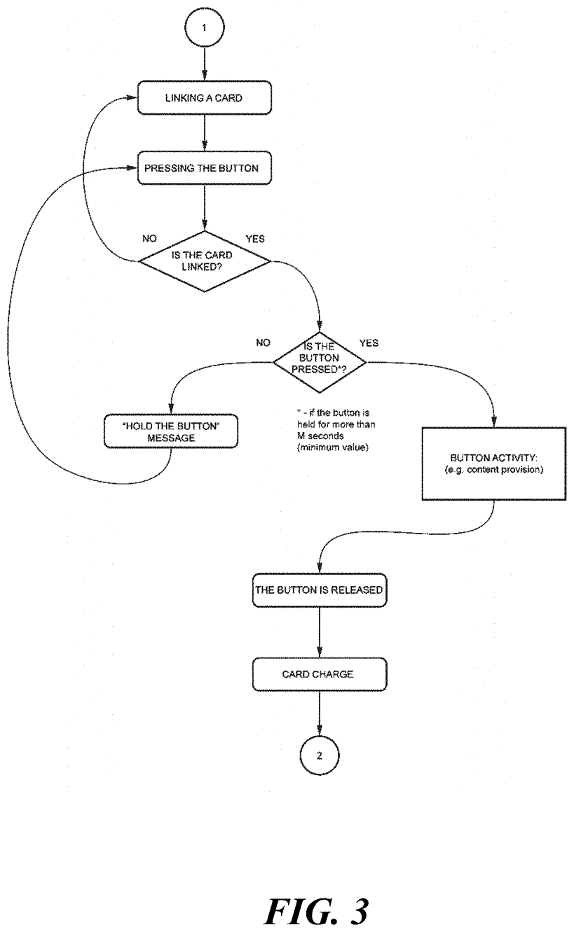

FIG. 4 presents a payment method, where the payer at the first stage holds the button, and at the second stage, after the button is released, the payment gateway opens and it is proposed to make payment for the generated amount.

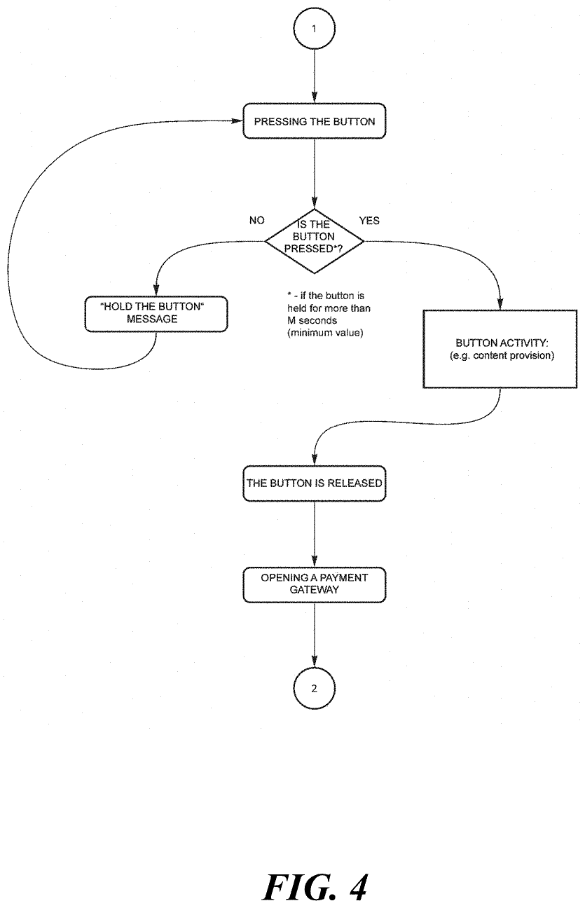

When holding the user interface button, you can observe, for example, playback of video and/or audio, graphic and photo materials or other type of content connected with the button. While the amount is being dialed, a video, audio file, graphic object or photo material is shown on the payer's display, the payer can press the button on the visual element of the button interface or on the video itself. At the moment when the button is released, payment is made. Playback of a unit of content will continue from the same place where it ended last time if the content was not viewed in full. When dialing the amount, the user display can open a text, play audio, video, photo, graphic content or animation and other actions. Vibration and Tapticengine can be supported for mobile devices.

What is claimed is:

1. A method for providing a commercial service focused on the content via the Internet using a processor-controlled device, the method includes the following steps:
connection of the consumer of Internet services via the aforesaid processor-controlled device to the Internet to the service provider;
check of payment of the above-mentioned consumer of Internet services;
initiation of the data streaming of said content-oriented Internet service to the Internet service consumer;
monitoring of the duration of the specified data streaming; and
simultaneous generation of the amount of payment for the service depending on the duration of its streaming, the specified control of the duration of the above data streaming being performed by initially pressing, holding and finally releasing the button on the above-mentioned processor-controlled device.

2. The method of claim 1, where the processor-controlled device comprises a smartphone.

3. The method of claim 1, where the processor-controlled device comprises a tablet.

4. The method of claim 1, where the processor-controlled device comprises a personal computer.

5. The method of claim 1, where the incremental amount of payment is transmitted to the consumer of Internet services during the streaming process.

6. The method of claim 1, where the button comprises a physical button on the processor-controlled device.

7. The method of claim 1, where the button comprises a virtual button on the processor-controlled device.
